(19) United States
(12) Patent Application Publication
(10) Pub. No.: US 2016/0323479 A1
(43) Pub. Date: Nov. 3, 2016

(54) METHOD OF SCANNING LARGE-FORMAT DOCUMENT WITH AUTOMATIC DYNAMIC SCALE CORRECTION

(71) Applicant: ROTH + WEBER GMBH, Niederdreisbach (DE)

(72) Inventor: Simon KAEMPFLEIN, Friedewald (DE)

(21) Appl. No.: 15/109,189

(22) PCT Filed: Jan. 21, 2015
(86) PCT No.: PCT/EP2015/051113

§ 371 Date: Jun. 30, 2016

(30) Foreign Application Priority Data
Jan. 21, 2014 (DE) 10 2014 201 035.7

(51) Int. Cl. H04N 1/393; H04N 1/193; H04N 1/19

(52) U.S. Cl. CPC H04N 1/393; H04N 1/1903; H04N 1/1933

(57) ABSTRACT

The invention relates to a method for scanning large-format scan templates (4) with an automatic dynamic scale correction function during the scanning process by means of a scanner (1) which has image capturing elements (2) arranged in a cascading manner in order to scan the scan template (4), wherein image information of adjacent sensor elements (11 to 14) is assembled by means of a stitching method and shift values (Vn) are ascertained in said elements. The method has the following steps: S1: deriving shift values (V) for each image line of the assembled image by interpolating the y direction components of the n shift values (Vn), S2: comparing the shift values (V) with a target value (S) in order to determine a relative deviation for each image line and adding the relative deviations until the sum has reached a value which corresponds to the smallest possible error correction for scaling the image information, and S3: scaling the image information or image signals by taking on the value for the error correction.

The invention relates to a method of scanning large-format documents with automatic dynamic scale correction function during the scanning process by a scanner that has image-capturing elements that scan the document, the image-capturing elements each being formed of at least two sensor elements arranged in a cascade with at least one area of overlap so that image information from the at least one area where the sensors overlap can be assembled by a stitching method, the at least one area of overlap being scanned for image information within a search area and shift values in both the x and y directions being determined by comparing congruent image information.

Scanning methods of this sort are used in particular for scanning documents that are large-format both in width and in length for which the scanning area of the scanner system is shorter than the document to be used.

Large-format scanner systems feed the document to be scanned over an image-capturing element or image sensor by transport rollers. As a result, continuous image-capturing elements, such as contact image sensors (CIS) that cover the entire scanning width can be used. This type of large-format scanner system is described in DE 10 2009 011 945 [US 2011/0310443], for example.

The use of multiple image sensors or sensor elements, such as line sensors like small CIS or CCDs, arranged next to each other, overlapping, in a cascade is also common in large-format scanner systems. The CIS image sensors used are also used in large quantities for small-format scanner systems (DIN A 3 or DIN A 4) in office environments and are therefore cost-effective.

For a true to scale scan of the document, it is necessary to ensure that the line frequency of the image sensors is always synchronous to the transport speed. With the use of stepper motors or encoders, the rotation speed of the transport rollers is known with sufficient accuracy. In practice, however, the transport speed may differ from the set point owing to mechanical tolerances (roller diameters, etc.) and in particular to slip during document transport. The likelihood of slip is increased for heavy documents and/or documents with smooth surfaces since the transport mechanism has to work against the force of the document's weight, particularly for large-format documents that are larger than DIN A3 where, in general, the scanning area on the scanner is significantly shorter than the document so that it hangs vertically down. Small ripples or creases in the document can also lead to errors. Compounding this is the fact that the transport speed, i.e. the processing speed for the document, may also be subject to minor variations during a scanning process because of this.

The problem of differences between the transport speed and the set point, caused for example by slip during document transportation, are known to be solved by the use of correction factors. To this end, the user can globally define a fixed correction factor. However, it is also possible to enter a correction factor individually for each scanning process. Various media types that, for example, have a surface with differing degrees of smoothness can also be assigned specific correction factors that can then be manually selected before each scanning process. This static correction method then has a fixed influence on the line frequency or the motor speed for the entire document to be scanned and corrects it. However, this is very laborious and error-prone for the users since they have to determine these correction factors for the different types of documents and then use them for each scanning process. In addition, it is also not possible to thus offset variations in the transport speed during the scanning process. It is therefore not possible to offset variations in the speed at which the template is transported resulting from guidance of the template by the user owing to unintentional braking of the template, for example, using the known static correction methods. Variations in the transport speed that arise as a result of heavy documents that initially hang down from the loading table and put a lot of strain on the template drive, then apply normal strain to the drive during the continuing transport and finally hang down from the loading table at the scanner output at the end of the scanning process and pull at the sheet feeder can also not be offset using the known static correction methods.

With image sensors arranged in a cascade, it is necessary to combine the image data from the individual image sensors together into a full image in order to achieve a continuous scan image across the entire scan width. The offset and the overlap between the individual image sensors in the x and y directions is corrected using suitable software tools, such as so-called stitching methods, in order to obtain a continuous scan image.

Alongside scanning processes that work with statically configured overlapping areas, there are processes that dynamically determine the offset in the time to run by the image information.

In WO 2012/146358 [U.S. Pat. No. 8,824,023], for example, a type of scanning process is described for a large-format scanner system that has image-capturing elements arranged with areas of overlap in a cascade in order to scan a large-format document, the image information in the areas where the image-capturing elements overlap is compiled using a stitching method, and the areas of overlap within a search area are scanned for image information and calculated by texture detection within the specified search area on the document, evaluation of the information density in the texture detected for determining a measure for the texture content, weighting of the information density depending on the measure for the texture content of the texture detected, detection of congruent image elements within the specified search area on the document, determining a weighted deviation for each measurement point from the weighting derived from the texture and the deviation determined for each measurement, determining a weighted average of the deviations from these weighted deviations and from this weighted average of the deviation from the shift values for correcting the position of the offset image elements, so that these image elements can be brought into alignment. To this end, the image elements captured by the second image-capturing elements in the scan path are moved to the congruent image elements captured by the first image-capturing elements in each case. As a result, distortions can occur in the compiled image as a result of unforeseeable movements that occur during the scanning process between the congruent image elements. A true to scale scan is not guaranteed.

From WO 2012/041389 [US 2013/0250371] a method of 2D measurement of the arrangement of image sensors for a scanner that scan a document overlapping area by area is known, and each sensor captures a two-dimensional image. The two images are correlated with one another in order to determine the movement in two directions or dimensions.

DE 36 11 984 [GB 2,175,170] reveals a document reader in which the phase difference for the driver impulses that are sent to the line sensors in accordance with the actual desired template reading scale can be varied. This allows the document reading scale to be steplessly adjusted. However, this stepless adjustment occurs according to specific criteria. Error detection during the scanning process and automatic and dynamic compensation for these errors in order to make automatic scaling corrections is not proposed here. US 2011/0292469 [U.S. Pat. No. 8,670,163] also reveals a dynamic stitching method in which congruent image content captured by sensor elements arranged in a cascade is compiled. Here, neither static nor dynamic scale correction is proposed.

The invention addresses the problem of implementing scale correction during a scanning process of the type specified above in a simple manner, in which errors resulting from deviation of the transport speed from the set point because, for example, the transport speed and the line frequency that are not synchronous owing to slip are automatically corrected and variations in the transport speed during the scanning process resulting from movement of the paper and/or loop formation, for example, are offset.

The problem is solved according to the invention for a method of the type described above by the characteristics set out in claim 1. Beneficial designs are set out in the subordinate claims.

The problem is solved according to the invention by the following steps:

S1) deriving shift values for each image line in the compiled image by interpolation of the y-direction components of the n shift values,

S2) comparing the shift values with a set point in order to determine relative deviation for each image line and addition of the relative deviations until their sum has reached a value that corresponds to the smallest possible error correction for scaling of the image information, and

S3) scaling the image information or image signals by acceptance of the value for error correction.

It is thus possible, in a simple manner, to perform scale correction in which errors resulting from deviation of the transport speed from the set point owing to asynchronous transport speed and line frequency as a result of slip are automatically corrected and variations in the transport speed during the scanning process resulting from movement of the paper and/or loop formation, for example, are offset. The scale correction is also dynamic since it is not statically applied to the entire compiled image but only to small areas of the image in accordance with the smallest possible error correction.

An average value can beneficially be generated from all shift values in the areas of overlap by determining the shift values in process step S1.

According to the invention, the set point can be determined from the physical spacing between the upstream and downstream sensor elements, in particular by measurement, or fixed in advance.

It has proven to be advantageous for the scaling in process step S3 to occur as image scaling though deletion of image lines in step S3a of the method or doubling of image lines in process step S3b or alternatively by correction of the line frequency or motor speed. In the course of this, the smallest possible error correction is considered to be when the sum of the relative deviations has reached, for example, the dimensions of a line to be added or removed, or the addition or removal of a stepper motor step or of a clock impulse in the clocking of the sensor elements.

It has proven to be advantageous to use filtering, particularly a moving average, of the shift values determined for the lines or for the spacing in image lines between the passage of the document at the upstream and downstream sensor elements to be determined for determining shift values in process step S1.

The invention is described in more detail below with reference to the embodiments shown in the drawings. Therein:

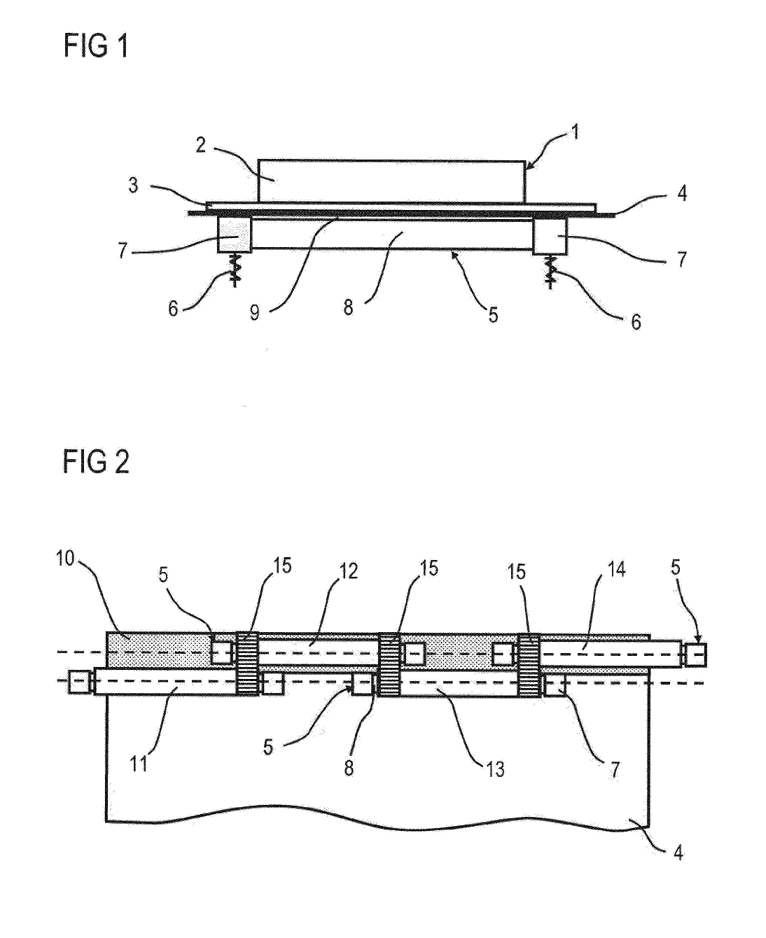

FIG. 1 shows a scanner with an image-capturing element and a reflector roller,

FIG. 2 shows a scanner with sensor elements arranged in a cascade,

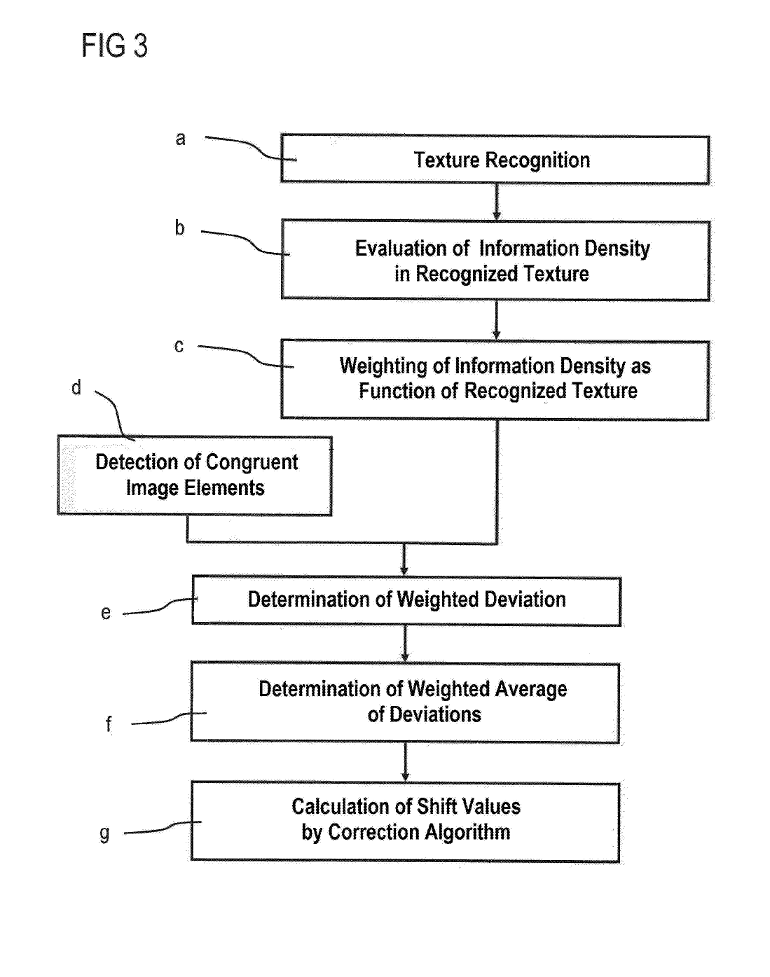

FIG. 3 shows process steps in a stitching method of the large-format scanner,

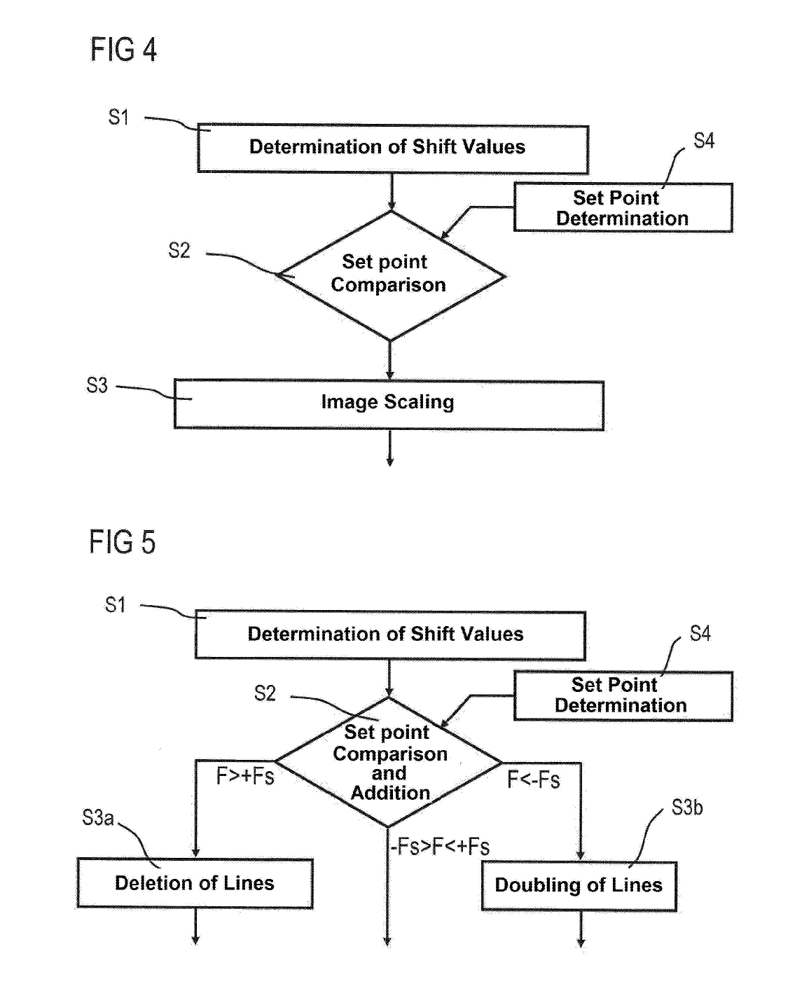

FIG. 4 shows the process steps according to the invention for automatic scale correction for the large-format scanner, and

FIG. 5 shows a refinement of the process steps according to the invention for automatic scale correction in accordance with FIG. 4.

FIG. 1 shows a scanner 1 with an image-capturing element 2 behind a pane of glass 3. A document 4 to be scanned is pressed by springs 6 against this pane 3 of glass by a reflector roller 5. The springs 6 engage ends 7 of the reflector roller 5 with force and thus press the reflector roller 5 against the document 4 to be scanned. The ends 7 of the reflector roller 5 have a larger diameter then a central part 8 of the reflector roller 5. This therefore forms a gap 9 at the central part 8 between the reflector roller 5 and the pane 3 of glass that is of a defined size to ensure optimal positioning of the document 4 to be scanned on the pane 3 of glass. In addition, the gap 9 in the central part 8 of the reflector roller 5 provides sufficient space for the document 4 to be scanned.

FIG. 2 shows the image-capturing element 2 comprising four sensor elements 11 to 14 arranged in a cascading or zig-zag manner for scanning a large-format document 4 to be scanned, shown in top view. Each sensor element 11 to 14 has a respective non-driven reflector roller 5 with large-diameter ends 7 flanking a small-diameter central part 8. The document 4 to be scanned has a search area 10 in which the system scans for image information using a stitching method in order to eliminate uncontrollable, non-linear information shifts resulting from variations in speed during transportation of the document 4 to be scanned under the sensor elements 11 to 14 arranged in a cascade.

The output signals from the image-capturing elements 2 are fed, in a known manner, to a processing circuit that compiles the image signals. In the scanning process according to the invention, an adaptive stitching method with dynamic correction algorithms, which is described below with the help of FIG. 3, is used for this.

The process sequence for the large-format scanner 1 as shown schematically in FIG. 2 is now explained in detail with the help of FIG. 3. In this process, the image information in the area of overlap 15 between the sensor elements 11 to 14 is compiled by a stitching method in that the area of overlap 15 is scanned for image information within a search area 10, as is described in more detail in WO 2012/146358, for example.

In the first process step a of the stitching method, texture detection is performed within the defined search area 10 of the document 4 to be scanned. In the second process step b, evaluation of the information density is performed in the texture detected in order to determine a measure for the texture content. This results in a third process step c comprising weighting of the information density depending on the measure for the texture content of the texture detected.

At the same time, in process step d, detection of congruent image elements is performed within the defined search area 10 of the document 4 to be scanned. With these values, a weighted deviation is determined in process step e for each measurement point from the weighting derived from the texture and the deviation determined. In process step f, a weighted average value for the deviations from these weighted deviations in determined from the weighted deviations for each pixel.

In process step g, a calculation of shift values for the correction of the position of the offset image elements so that this image element is brought into alignment results from this weighted average value for the deviations.

FIG. 4 shows the process steps that are essential to the invention for the scanning process with automatic scale correction according to the invention for the large-format scanner 1. In process step S1, the shift values are determined by interpolation of the y-direction component of the shift values determined though process steps a to g in the stitching method.

These shift values V are graded in a set-point comparison in process step S2 and then added until their sum has reached a value that corresponds to the smallest possible error correction for scaling the image information.

In process step S3, scaling of the image information or image signals is done by acceptance of the value for error correction.

The comparative data, namely the set points S required for the set-point comparison in process step S2, is determined in the process step S4 in which the physical spacing between the upstream and downstream sensors is determined by measuring, for example, or fixed in advance.

FIG. 5 now shows a refinement of the process steps that are essential to the invention for automatic scale correction for the large-format scanner 1 in FIG. 4. The shift values V are determined in process step S1.

The set-point comparison that is performed in process step S2 leads, where applicable, to deviations that are added. If the totaled deviations F exceed the positive or negative threshold value ±Fs corresponding to the smallest possible error correction, then different process steps are initiated. If the deviations F exceed the threshold value +Fs (F>+Fs) then image lines are deleted or suppressed in process step S3a. If the deviations F are less than the threshold value −Fs (F<−Fs), then line doubling is prompted by process step S3b. If the deviations F are between −Fs and +Fs (−Fs>F<+Fs), then the image information or image signals are left unchanged.

The method of automatic scale correction according to the invention uses the shift values determined by a stitching method in order to perform dynamic scale correction in real time.

The dynamic stitching method described above determines a shift value in the direction of movement for each image line of the compiled image and each area of overlap 15 that indicates the spacing in image lines between the passage of the document, the document 4 to be scanned, at each upstream and downstream sensor element 11 to 14. If the stitching method only determines a shift value for each n^{th} image line, then a shift value for each line can be derived by interpolation of the shift values. For multiple areas of overlap 15, the new method first generates an average value for all of the shift values for the areas of overlap 15. Set-point comparison S2 with the physical spacing between the upstream and downstream sensors 11 to 14 as the set point as determined by measurement for instance or predetermined, allows the new method to determine the relative deviation for each image line.

In the course of this, a deviation from the set point can have two causes, for example:

The transport speed and line frequency are not synchronous (slip, etc.)

The document section (image line) does not span the spacing between the upstream and downstream sensors by the shortest route. This can occur as a result of movement of the paper and/or loop formation.

If mechanical means can be used to ensure that the document has the same length in the middle between the upstream and downstream sensor elements 11 to 14, the shortest path for example, then the method can determine the scale deviation approximately with suitable filtering, for example a moving average or moving weighted averaging of the deviations determined for the lines, and correct it by scaling of the image, for example by deleting (S3a) or doubling (S3b) image lines.

1. A method of scanning large-format documents with automatic dynamic scale correction function during the scanning process by a scanner that has image-capturing elements that scan the document, the image-capturing elements each being formed of upstream and downstream sensor elements spaced longitudinally in a document-travel direction in a cascade with at least one area of transverse overlap so that image information from the at least one area of overlap between the sensor elements can be assembled by a stitching method, the at least one area of overlap being scanned for image information within a search area and shift values in both the longitudinal and transverse directions being determined by comparing congruent image information, with the following steps:
S1) deriving shift values for each image line in the compiled image by interpolation of transverse components of n shift values,
S2) comparing the shift values with a set point in order to determine a relative deviation for each image line and addition of the relative deviations until their sum has reached a value that corresponds to the smallest possible error correction for scaling of the image information, and
S3) scaling the image information or image signals by acceptance of the value for error correction.

2. The method according to claim 1, wherein determining shift values in process step S1 generates an average value of all shift values in the area of overlap.

3. The method according to claim 1, wherein the set point is determined from a physical longitudinal spacing between the upstream and downstream sensor elements, by measurement, or is fixed in advance.

4. The method according to claim 1, wherein the scaling in process step S3 is done as image scaling by deletion or doubling of image lines.

5. The method according to claim 1, wherein the scaling in process step S3 is done by correction of the line frequency and/or motor speed.

6. The method according to claim 1, wherein a moving average of the shift values determined for the lines is used for determining the shift values in process step S1.

7. The method according to claim 1, wherein a spacing in image lines between the passage of the document past the upstream and downstream sensor elements is determined for determining the shift values in process step S1.
